(19) United States
(12) Patent Application Publication
(10) Pub. No.: US 2014/0261198 A1
(43) Pub. Date: Sep. 18, 2014

(54) PET AND ANIMAL WATER DISPENSER

(71) Applicant: Lawrence I. Wechsler, Great Neck, NY (US)

(72) Inventor: Lawrence I. Wechsler, Great Neck, NY (US)

(21) Appl. No.: 13/841,105

(22) Filed: Mar. 15, 2013

(51) Int. Cl. A01K 5/02

(52) U.S. Cl. CPC A01K 5/0225
USPC 119/52.1

(57) ABSTRACT

A dispenser for flowable consumables includes a tray containing a pooling space in which contents from a bottle can be selectively transferred. The bottle is pivotably mountable to the tray via coupling structure which engages the bottle and carries pivot structure engageable hingeably with the tray. Since the engagement structure is carried in a reliably fixed position relative to the bottle, desired relative rotational positioning with respect to the tray is assured

### CROSS REFERENCE TO RELATED APPLICATIONS

This application claims the benefit of U.S. Provisional Application Ser. No. 61/765,881 filed Feb. 18, 2013 entitled PET WATER DISPENSER.

### BACKGROUND OF THE INVENTION

The present invention relates to a portable device for selectively dispensing feed material, particularly water and flowable feed, to animals, and more particularly to a device which is useful for dispensing water, potable liquids, granulated solids and other flowable consumables from a reservoir (otherwise interchangeably referred to as a “bottle” herein) into a pooling region for consumption thereof by a pet or other animal.

A device was previously suggested in U.S. Pat. No. 5,636,592 issued to Wechsler, which includes a trough having a shape allowing at least partial nesting of a suitably configured and sized reservoir therein. The reservoir is movable between a first position and a second position relative to the trough, such that when in the first position, the reservoir and trough are nested, and when moved to the second mounted position, the reservoir is brought out of nesting position and is clear of the trough for animal access to contents in the trough selectively transferred thereto from the reservoir.

While providing particularly compact travel advantage by allowing at least partial nesting of reservoir and trough, the specific examples of mounting structure effective for connecting the reservoir to the trough which are described in the detailed examples, are well suited to use with a reservoir (e.g. a bottle) of generally circular cross-sectional shape, but create some difficulty when applied to a bottle of other, perhaps flattened or out-of-round, shape. As shown in the detailed examples depicted in the aforementioned reference, the mounting of the bottle to the hingable tray is implemented by use of a pivot mechanism carried on, for example, a threaded coupling member (cap), to which the bottle is received during use, and the bottle/cap combination is hingably mounted to the tray via the cap portion. As such, when the bottle is threaded to the coupling member (cap) with the tray pivoted thereto, there is no assurance that the bottle will be oriented in any particular desired rotational position when fully tightened. While some control can be maintained by orienting the threads such that the bottle reaches a tightened position in a desired orientation, variations in molding and plastic characteristics will not always result in perfect rotational alignment between bottle and tray when tightened, and therefore makes the use of a flattened bottle imperfect.

Furthermore, a further drawback of the approach described in the aforementioned patent reference resides in the fact that the location of the pivot axis is restricted within a limited region of the cap portion. Little or no flexibility as to where a pivot for providing hingable movement between the reservoir and the trough can be located is permitted by the described structural aspects.

Still further, because the pivot is located on the cap portion, the device cannot be refilled simply by unscrewing the cap, but instead requires that the bottle be unscrewed from the rest of the device and filled after separation therefrom.

It would therefore be desirable to provide a dispenser from which an animal could be fed water or flowable solids, and which would be readily adaptable to use with a wide range of differently shaped reservoirs (e.g., bottles), in particular, flat bottles, such as a hip flask type shape. Further, it would be desirable to provide a dispenser in a form which could be refilled simply by removal of a cap portion, and in which a location of a pivot which hingably links a reservoir and trough is freely selectable, as a particular design requirement may dictate.

### SUMMARY OF THE INVENTION

Accordingly, it is an object of the invention to provide a feed dispenser for animals, for dispensing water, potable liquids, granulated solids and other flowable consumables for consumption thereof, which overcomes the drawbacks of the prior art.

It is a further object of the invention to provide a dispenser capable of administering liquids, which is portable, and in which a desired circumferential positioning of a bottle relative to a pivoted tray can be assuredly maintained, irrespective of bottle shape.

It is a still further object of the invention to provide the dispenser in a form which is compact, easy to operate and which may be produced economically.

In accordance with these and other objects of the invention, there is provided a dispenser which includes a tray (open top trough) containing a pooling space in which contents from a reservoir can be selectively transferred. The reservoir, conveniently in the form of a squeezable bottle, is pivotably mountable to the tray via a coupling which is engageable with the bottle, and which carries engagement structure pivotably engageable with the tray. Since the engagement structure for pivotable mounting is carried in a reliably fixed position relative to the bottle, desired relative rotational (circumferential) positioning (e.g., about a central bottle axis) with respect to the tray is assured.

In an advantageous embodiment, the coupling comprises a clip which provides a snap engagement with the bottle, for example, clipping around the bottle or into grooves or other engagement structure provided laterally on the bottle. The clip also advantageously includes pivot structure, for example in the form of protrusions (e.g., pins) receivable in pivot holes formed in the tray, or vice versa (i.e., pins on the tray and recesses or holes in the clip). The sides of the tray are then simply flexed apart for assembly to allow the protrusions to be bilaterally received in the holes (or inner facing indentations) in the tray for captive relative rotation, in and out of closed and use positions, respectively, when the temporary deformation stress is relieved in the tray sides. Alternatively, the portion of the clip carrying the pivot structure can be inwardly flexed to create the required clearance between the tray and the clip allowing the reception of the protrusions in the recessed accommodating structure.

In a particularly advantageous embodiment, the bottle and tray are configured such that the bottle can at least partially nest in a feed pooling space of the tray (more advantageously have approximately mutually conforming shape), and optionally, the overall shape of the device when so nested (closed position) approximates that of a conventional hip flask design (i.e., generally convex on one side and concave on the other side) such as is used commonly, for example, in bottling liquor for portable consumption.

The above, and other objects, features and advantages of the present invention will become apparent from the following description read in conjunction with the accompanying drawings.

### BRIEF DESCRIPTION OF THE DRAWINGS

FIG. 1 is a perspective view of a dispenser shown in a closed position with the bottle nested in the tray;

FIG. 2 is top view of the dispenser of FIG. 1, shown in the closed (nested) position;

FIG. 3 is a front elevational view showing the dispenser of FIG. 1 in the closed (nested) position;

FIG. 4 is a side elevational view showing the dispenser of FIG. 1 in the closed (nested) position;

FIG. 5 is a bottom view showing the dispenser of FIG. 1 in the closed (nested) position;

FIG. 6 is a perspective view showing the dispenser of FIG. 1 in an open (active use) position, with the tray pivoted clear of the bottle; and

FIG. 7 is an exploded view depicting the various components comprising the device of FIG. 1.

### DETAILED DESCRIPTION OF THE PREFERRED EMBODIMENT

Referring now to the figures, a dispenser in accordance with an embodiment of the invention is shown generally at 10. Dispenser 10 includes a bottle 1 (serving as a reservoir) and a tray 2 which are advantageously configured, as shown, to permit bottle 1 to nest in a pooling space (inside of the trough shape) of tray 2. A cap 3 for closing the bottle 1 is advantageously provided (which may be optionally valved, or not). In the depicted embodiment, cap 3 optionally includes a valve portion 3a. For purposes of example, the optional valve portion depicted is a standard and notoriously well-known push-pull valve type commonly used on sport bottle, and therefore further detailed description of structure and function are omitted herein as deemed unnecessary. Other valves, either manually operated or automatically actuated in response to a hinging motion are also contemplated as optional alternatives.

Dispenser 10 further includes coupling structure for interconnection between the tray 2 and bottle 1, advantageously provided in a form of a resiliently deformable clip 4 (for example, made of a suitable plastic or metal). Clip 4 is structurally configured to engage the bottle 1 in a manner providing removable mounting thereto. Bottle 1 advantageously includes a recessed portion 1a in which the clip 4 is received so that it lies generally flush with adjacent surfaces of bottle 1. In the depicted example, engagement of clip 4 with bottle 1 is advantageously achieved by a snap-type clamping structure 4a which engages indentations 1b formed bilaterally in the bottle 1. Clamping structure 4a is outwardly deformed to clear the sides of the bottle 1, and when released, ends thereof are received in the indentations 1b, to maintain the clip 4 in captive engagement with the bottle 1. Alternatively, the indentations 1b can be omitted, and the clamping structure configured to wrap around to the opposite side of the bottle. Further, it is noted that, alternative to providing either indentations 1b for receiving the ends of clamping structure 4a or clamping structure 4a, any other suitable configuration for achieving mounted engagement of clip 4 to bottle 1, removable or otherwise, can be employed without departure from the invention. For example, any other type coupling member or structural adaptation can be used in place of a clip, and need not for example, per se “clip” to the bottle, and other suitable engagement, such as, including but not limited to, slideable, fastenable, glueable, press-fit, etc. can be employed within the contemplated scope of the invention.

In the depicted example, the clip 4 further includes a pair of bilateral support extensions 4b, carrying thereon, pivotable engagement structure, conveniently in the form of protrusions (pins) 4c facing in opposed directions which are receivable in corresponding holes 2a in tray 2, to achieve pivotable mounting of tray 2 to bottle 1 via clip 4. Such structure allows the bottle 1 to captively pivot about a pivot axis A which, in the example shown, runs cross-wise to a central bottle axis B. It is noted that any other structure which provides pivotable or hingeable interconnection between bottle 1 and tray 2 can alternatively be employed without departure from the invention.

As best seen in FIG. 7, bottle 2 optionally has a “hip flask” shape presenting a (side-to-side) convex back surface 5 and concave front surface 6, for greater comfort (i.e., conformability to the body of the user) when being carried in a pants pocket, etc. Also, tray 2 advantageously laterally tapers at the location of the pivot axis A.

To use dispenser 10, valve portion 3a is opened, and bottle 1 pivoted open to the position shown in FIG. 6. Advantageously, the tray 2 and clip 4 are configured such that the movement of bottle 1 relative to tray 2 is prevented beyond a comfortable hand-held feeding angle, as shown in FIG. 6. To feed, the bottle is held by a user, and the contents are transferred to the tray 2 conveniently by squeezing the bottle 1, from which pooled feed, for example, water, can then be accessed. When finished with a feeding/watering operation, the dispenser 10 is restored to the closed position shown in FIG. 1 by pivoting bottle 1 back, to advantageously nest in tray 2, and the valve portion 3a closed, either before pivoting or afterwards. Advantageously, as shown, tray 2 does not extend fully above cap 3, so that it is easily unscrewed for refilling. Further, as illustrated, an optional opening 4d is provided in clip 4 which allows finger access to both sides (front and back of the cap 3) for facilitated screwing and unscrewing thereof. Optionally, as shown, the pair of bilateral support extensions 4b are interconnected by a cross-support portion 4e for improved stability against torsional distortion.

It is noted that the above described structural approach readily permits the pivot location providing hingeable mounting of the tray to the bottle to be positioned virtually anywhere relative to the bottle and tray. While in the depicted example, the pivot location is above the base of the cap, adjacent to the valve portion, there may be other embodiments according to the invention in which the pivot position would be better suited to location below the cap, or even below the cross-band of the clip (i.e., the portion of the clip 4 that spans the width of the bottle 1), adjacent to the body of the bottle, and such variation is deemed to be within the scope of the invention as contemplated.

The entirety of U.S. Pat. No. 5,636,592 issued to Wechsler is incorporated by reference.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A dispenser for flowable consumables, comprising:
a tray;
a bottle; and
coupling structure which provides mutual engagement with each of the bottle and tray, said coupling structure being engageable with the bottle in a fixed position relative thereto, and including structure for providing pivotable mounting thereof to said tray.

2. A dispenser according to claim 1, further comprising a valve receivable to the bottle.
